(19) United States
(12) Patent Application Publication
(10) Pub. No.: US 2012/0171341 A1
(43) Pub. Date: Jul. 5, 2012

(54) METHOD AND DEVICE FOR ADMINISTERING MEDICATION TO ANIMALS

(76) Inventor: Robert WEISS, Healdsburg, CA (US)

(21) Appl. No.: 12/982,574

(22) Filed: Dec. 30, 2010

(51) Int. Cl. A47J 43/00; A23K 1/00

(52) U.S. Cl. 426/280; 99/485

(57) ABSTRACT

A device comprising a body portion having a hollow inside and a plunger portion configured to move up and down within the body portion; a cavity defined by the plunger portion and the body portion when the plunger is in a down or substantially down position; wherein the device is configured to administer a medication to an animal and/or to create a nugget out of a pill and a treat that will be administered to an animal.

### FIELD OF THE INVENTION

The present invention is directed to a method and device for administering medication to animals, specifically a device that compresses and integrates an animal treat and a pill, and methods of using the same.

### BACKGROUND OF THE INVENTION

Animals, such as dogs and cats and other pets, need to take certain medications and vitamins. Not every animal owner is blessed with an animal that takes its medications and vitamins wholeheartedly. As such, pills may be hidden in such foods as slices of cheese or covered with peanut butter to mask the pill and add an element of attraction in terms of smell and flavor so that the pet will eat the pill. However, since the animal owner is simply rolling the cheese around the vitamin or medication, the vitamin or medication may not integrate with the treat or may be loose inside. As such, the animal may, upon consumption, sense the vitamin or medication within the treat and thus not want to eat it. Accordingly, there is a need for a nugget that has a pill or vitamin that is more integrated with the treat.

### SUMMARY OF THE PREFERRED EMBODIMENTS

In accordance with a first aspect of the present invention, there is provided a method of administering a nugget to an animal and/or for creating a nugget out of a pill and a treat that will be administered to an animal. The method includes providing a device comprising a body portion having a hollow inside and a plunger portion configured to move up and down within the body portion, wherein the plunger portion is housed at least partially within the body portion; pulling the plunger portion to a down or substantially down position within the body portion, wherein pulling the plunger portion to the down position or substantially down position exposes a cavity for receiving an animal treat and a pill; placing the animal treat inside the cavity and then pushing the pill down into the treat; and thereby creating an integrated nugget. Preferably, the treat is held within the cavity of the device so as to not allow expansion or breaking of the treat and thereby integrating the treat and the pill into one nugget.

In accordance with another aspect of the present invention, there is provided a device. The device includes a body portion having a hollow inside and a plunger portion configured to move up and down within the body portion; wherein the plunger portion is housed at least partially within the body portion; and a cavity exposed by the downwardly movement of the plunger portion; wherein the cavity is adapted to receive an animal treat and an animal medication.

In accordance with another embodiment of the invention, there is provided a kit for administering a medication to an animal and/or for creating a nugget out of a pill and treat that will be administered to the animal. The kit preferably includes a device and one or more treats with a suitable moisture content as disclosed herein.

In accordance with another aspect of the present invention, there is provided a device. The device includes a body portion having a hollow inside and an outer plunger portion configured to move up and down within the body portion. The outer plunger portion is housed at least partially within the body portion. The device further includes an inner plunger portion configured to move up and down within the outer plunger portion. The inner plunger portion is housed at least partially within the outer plunger portion. The device further includes a cavity exposed by the downwardly movement of the outer plunger portion; wherein the cavity is adapted to receive an animal treat. In one aspect, the device may include an inner cavity exposed by the downwardly movement of the inner plunger portion; wherein the inner cavity is adapted to receive at least one pill.

In accordance with another aspect of the present invention, there is provided a method of administering a pill in a treat to an animal. The method includes providing a device. The device includes a body portion having a hollow inside and an outer plunger portion configured to move up and down within the body portion. The outer plunger portion is housed at least partially within the body portion. The device further includes an inner plunger portion configured to move up and down within the outer plunger portion. The inner plunger portion is housed at least partially within the outer plunger portion. The device further includes a cavity exposed by the downwardly movement of the outer plunger portion; wherein the cavity is adapted to receive an animal treat. In one aspect, the device may include an inner cavity exposed by the downwardly movement of the inner plunger portion; wherein the inner cavity is adapted to receive at least one pill.

### BRIEF DESCRIPTION OF THE DRAWINGS

The invention may be more readily understood by referring to the accompanying drawing in which:

FIG. 1 is a perspective view of a device having a plunger portion and a body portion in accordance with a preferred embodiment of the invention;

FIG. 2 is a side elevational view of device of FIG. 1;

FIG. 3 is a cross-sectional side elevational view of device of FIG. 1, taken along the line 3A-3A of FIG. 2;

FIG. 4 is a perspective view of plunger portion of FIG. 1;

FIG. 5 is a side elevational view of plunger portion of FIG. 1;

FIG. 6 is a cross-sectional side elevational view of plunger portion of FIG. 1, taken along the line 6A-6A of FIG. 5;

FIG. 7 is a detailed side elevational view of plunger portion of FIG. 6, taken at 7B;

FIG. 8 is a perspective view of the body portion of device of FIG. 1;

FIG. 9 is a top plan view of body portion of device of FIG. 1;

FIG. 10 is a side elevational view of body portion of FIG. 1;

FIG. 11 is a cross-sectional side elevational view of body portion of FIG. 1; taken along the line 11A-11A of FIG. 10;

FIG. 12 is a perspective view of a device in accordance with another preferred embodiment of the present invention;

FIG. 13 is a side elevational view of the device of FIG. 12; and

FIG. 14 is a cross-sectional side elevational view of the device of FIG. 12; taken along line 14A-14A of FIG. 13.

Like numerals refer to like parts throughout the several views of the drawings.

### DETAILED DESCRIPTION OF THE PREFERRED EMBODIMENTS

It will be appreciated that terms such as “front,” “back,” “top,” “bottom,” “left,” “right,” “horizontally,” “up,” “down,” “upwardly,” “downwardly” and “side” used herein are merely for ease of description and refer to the orientation of the components as shown in the figures. It is to be understood that any orientation of the device, and the components thereof described herein, is within the scope of the present invention.

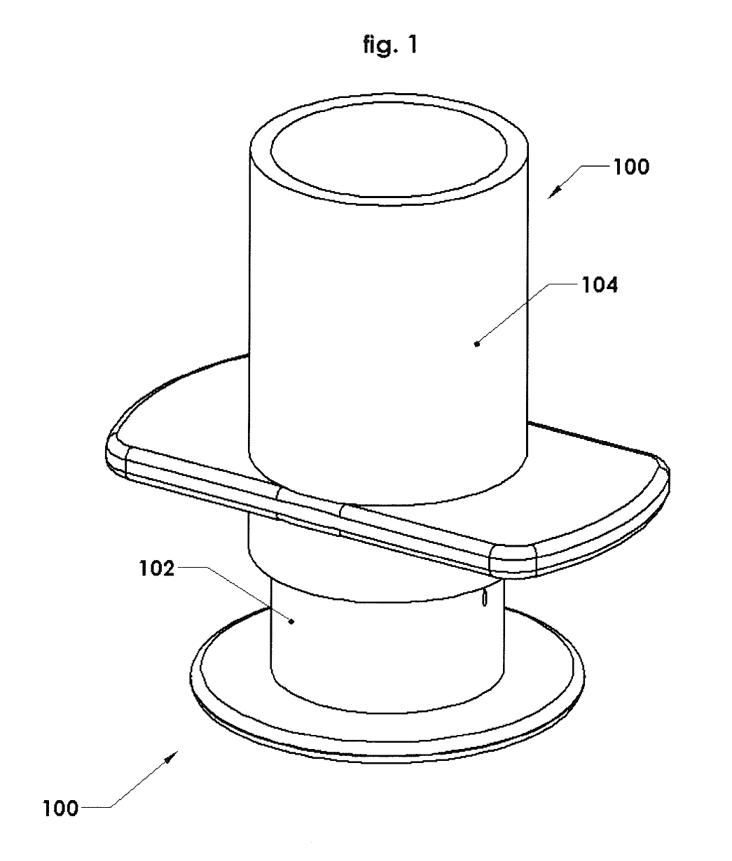

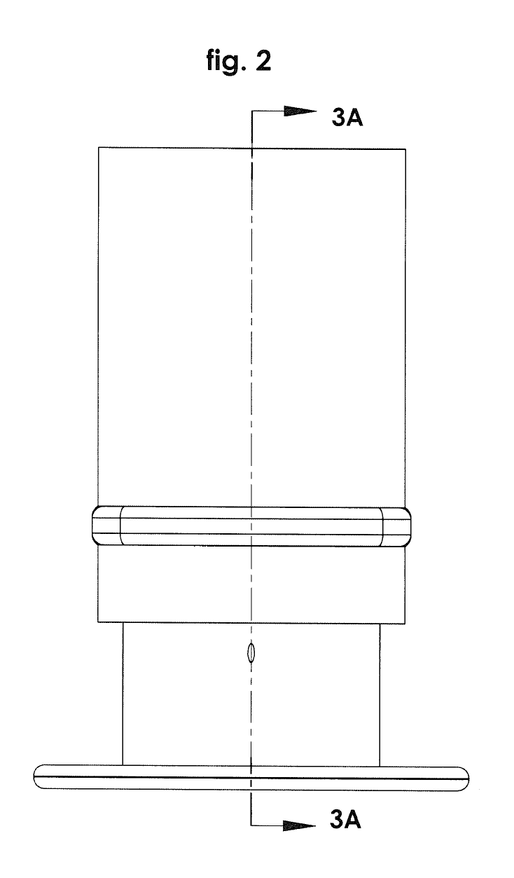

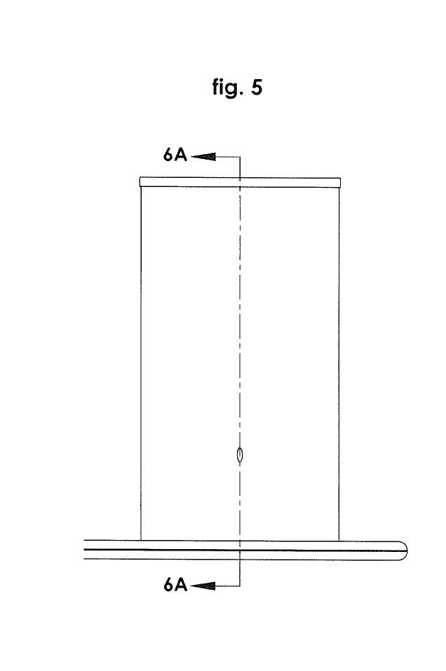

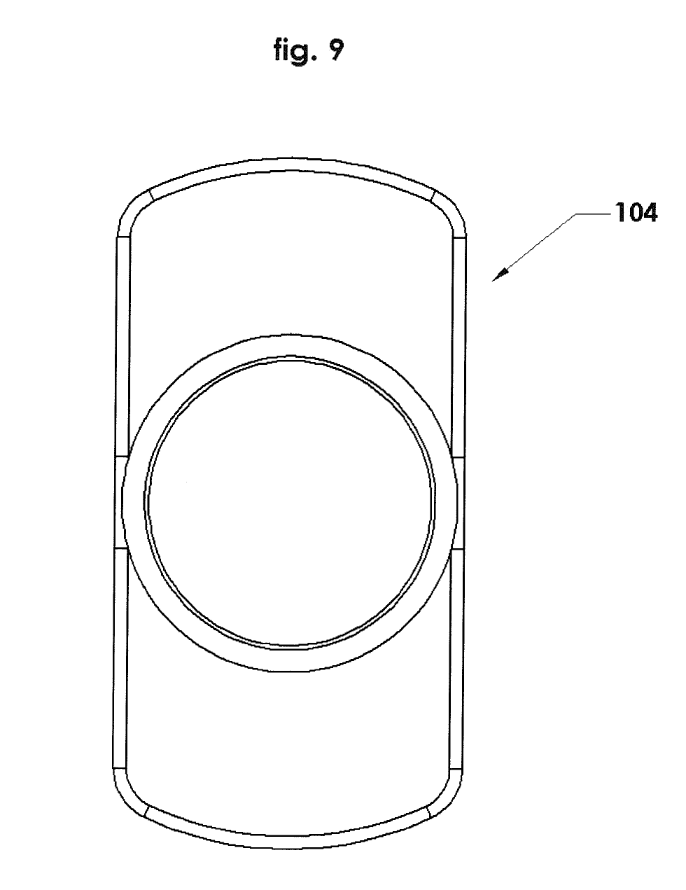

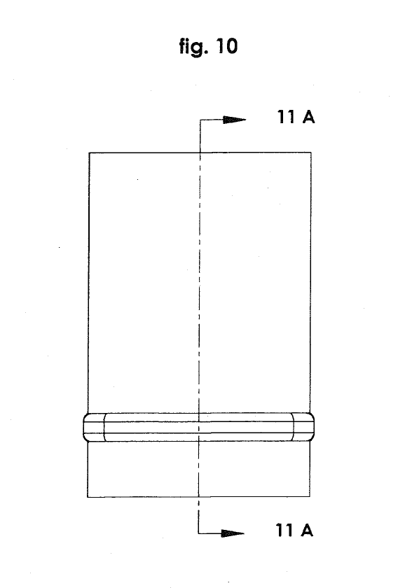

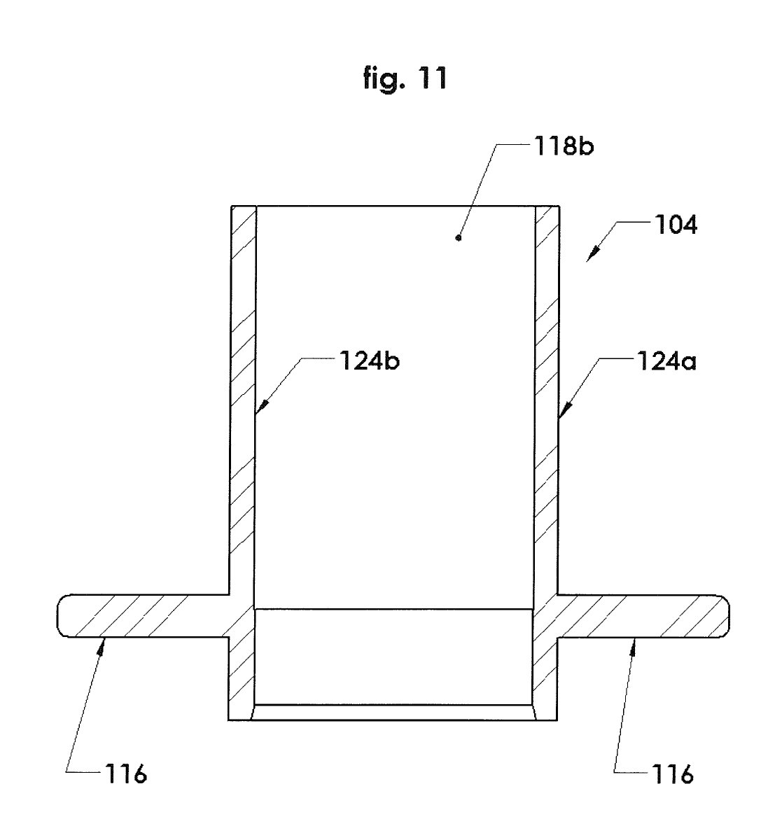

Referring to FIGS. 1-11, a preferred embodiment of a device 100 is shown and described. Generally, device 100 includes a plunger portion 102 and a body portion 104. Preferably, plunger portion 102 is configured to fit snugly inside body portion 104 and to move up and down within body portion 104 when pushed or pulled. As such, plunger portion 102 has an up or substantially up position and a down or substantially down position. Animal treat and pill may be placed under plunger portion 102 when plunger portion 102 is in a down or substantially down position. Pushing up on plunger portion 102 compresses any animal treat and/or pill under it. As such, a compressed treat and pill combination is created. This combination may be referred to herein as a “nugget.” Since the pill is compressed within the treat in the nugget, the “bad” taste of the pill is masked by the “good” taste of the treat/nugget. Using the hands alone with a treat will not accomplish this level of compression and integration. The treat will tend to fall apart without the use of the device of the present invention.

As used herein, “treat” or “animal treat” refers to any dog/cat/horse/fish/pet/animal food with a suitable softness, consistency, and/or moisture content. In a preferred embodiment, the treat of the present invention has a moisture content of from about 5 to about 60 percent by weight; more preferably from about 10 to about 50 percent by weight; and most preferably from about 20 to about 32 percent by weight. The moisture content may be provided by water, glycerin, and/or any other component, or combinations thereof. A treat prepared with the appropriate moisture content preferably will not break or fall apart when the plunger portion is pushed into it. In other embodiments, the moisture content of the treat may be less than about 5 or more than about 60.

In a preferred embodiment, the treat also includes a protein source in accordance with the American Association of Feed Control Officials (“AAFCO”). The protein source may vary depending on government minimums and maximums, and may come from any animal or vegetable material or combinations thereof. Preferably, the treat includes one or more fats and/or fiber that are not less than, or more than, the AAFCO requirements for the specific animal. The treat may also include an attractant to allow the animal to desire to eat the treat. The attractant, for example, may be a scent to mask the smell of the pill. In other embodiments, the protein source, fats, and/or fiber may be omitted and/or replaced by other suitable ingredients. In yet other embodiments, the treat may be produced in accordance with other guidelines or guidelines from other regulatory agencies.

In a preferred embodiment, the treat is manufactured as follows. The ingredients of the treat, i.e., the liquids and flour, are mixed together in a live bin that may mix both liquids and flours. Preferably, once the ingredients are blended, they may go to a pre-conditioner. Screws from about 3 inches to about 5.25 inches may be used. Thereafter, the mixture may be placed in a Wenger X-25 extruder. The extruder may compress the treat and extrude it through one or more holes, whereby a Wenger cutoff knife, or other suitable device, may cut the treat off at a desired length. Preferably, the knife runs at about a 10 to about 30 Hertz frequency. The speed of extrusion may vary from about 400 to about 1200 rpm. The shape and/or size of the one or more holes may be varied to extrude treats of different sizes and shapes. As such, the extruder may have holes of varying shapes and sizes in a single extrusion machine. After extrusion, the treats may be dusted with a powder to prevent them from sticking together. Preferably, the extruder is maintained at a temperature not exceeding about 185° F., in order to prevent the heat from the process from damaging the treats. In other embodiments, other means may be used to prevent the treats from sticking together after extrusion. In other embodiments, another brand/model/type of extruder, and/or another suitable mechanism in lieu of an extruder, may be used to manufacture treat. In other embodiments, the live bin and/or pre-conditioner may be omitted or replaced with another suitable device. In yet other embodiments, other means of manufacturing the treats may be used, i.e., injection molding, and/or the treats may be obtained pre-made from a supplier. In yet other embodiments, the frequency of the knives; the speed of extrusion, or the like may be varied.

As used herein, “animal” refers to a dog, cat, horse, fish, or any other animal and/or pet. “Pill” refers to any animal medication or vitamin. “Nugget” as used herein refers to a combination of the treat and pill produced by the device of the present invention. Generally, “treat” refers to the tasty portion, and “pill” refers to the less tasty portion, of the nugget. As such, “treat” as used herein may refer to any animal/pet food that the animal/pet finds to be tasty. As used herein, “device” may be referred to as “device”, “device for administering medication to animal(s),” and/or “assembly.” As used herein, “method for administering medication to animals” may be referred to as “method for creating a nugget out of a pill and a treat that will be administered to the animal.

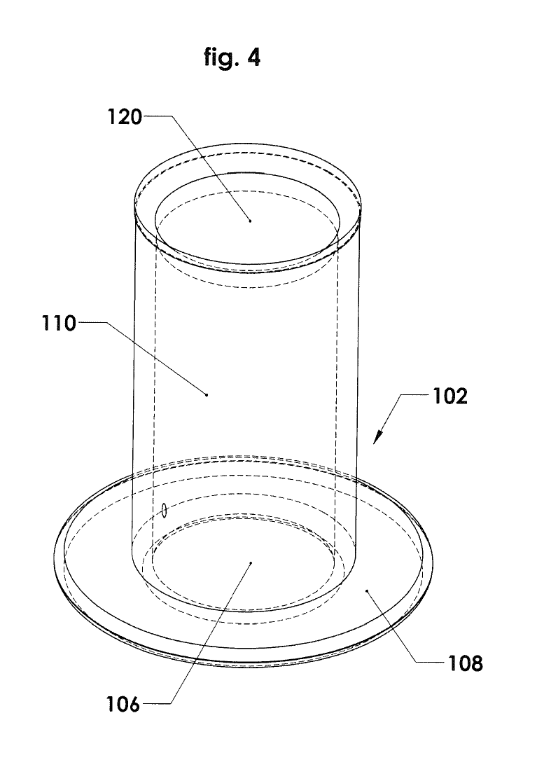

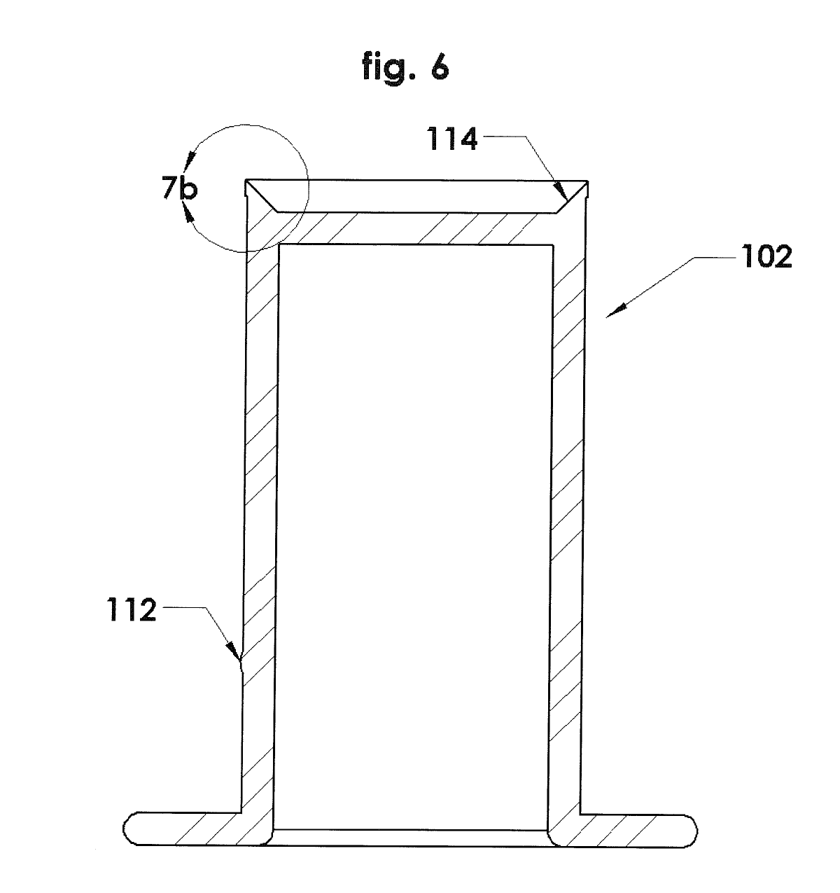

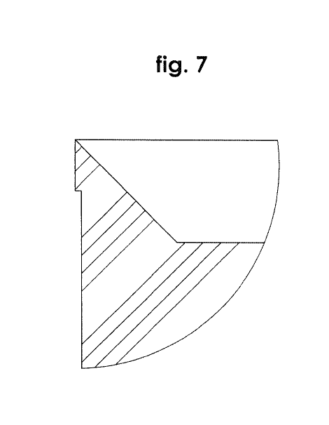

In a preferred embodiment, and referring to FIG. 4, plunger portion 102 includes a cylinder 110 and a top 108 that is attached, or formed as part of, cylinder 110 on a top portion of cylinder 110. Top 108 is preferably disc-shaped and, along with cylinder 110, forms an opening 106 at top portion of cylinder 110. Referring to FIG. 6, cylinder 110 also includes a solid bottom 120 and a hollow inside. Preferably, cylinder 110 includes two detents 112 (referred to herein singularly and collectively as “112”) on its outer surface. Preferably, and as best shown in FIGS. 6 and 7, plunger portion 102 includes two beveled edges 114 (referred to herein singularly and collectively as “114”) at bottom 120 of cylinder 110. In other embodiments, one or more of detents 112 are omitted, and/or are replaced by other suitable components for resisting motion. In other embodiments, one or more of beveled edges 116 are omitted, and/or replaced by other suitable components. In other embodiments, cylinder 110 may not have a hollow or substantially hollow inside, i.e., it may have a solid inside. In yet other embodiments, cylinder may not have a solid bottom, i.e., may have a partially solid bottom.

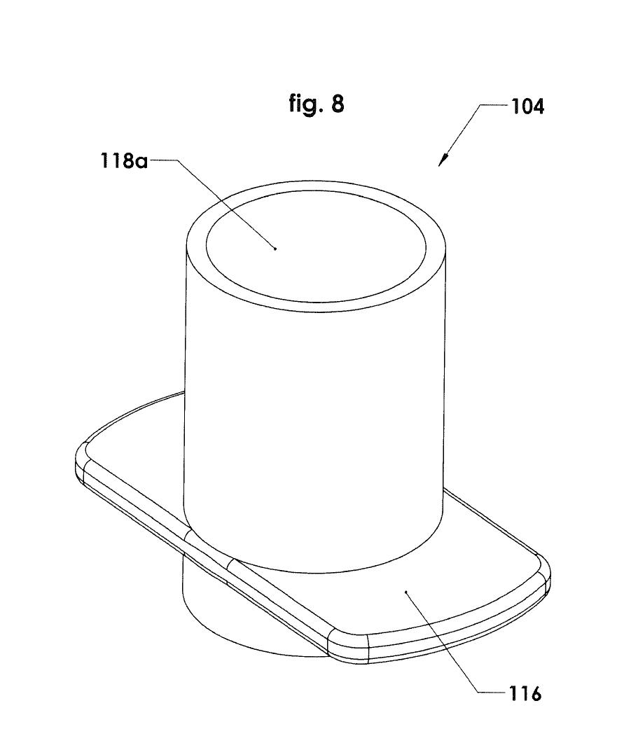

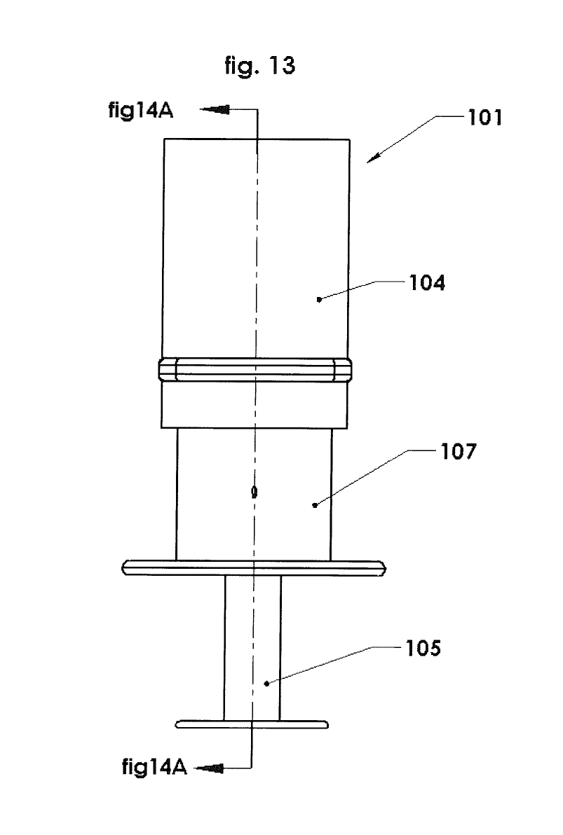

In a preferred embodiment, and referring to FIGS. 8-14, body portion 104 is cylindrical in shape and has two openings 118a and 118b. The diameter of each of the openings 118a and 118b may or may not be the same. Body portion 104 defines a hollow interior. Body portion 104 preferably includes protrusions 116 (referred to herein singularly and collectively as “116”) on its outer surface 124a. Protrusion 116 allows the user to grip device 100 easily while pushing up on plunger portion 102. In other embodiments, one or more protrusions 116 is omitted, or replaced with other suitable components for gripping device 100.

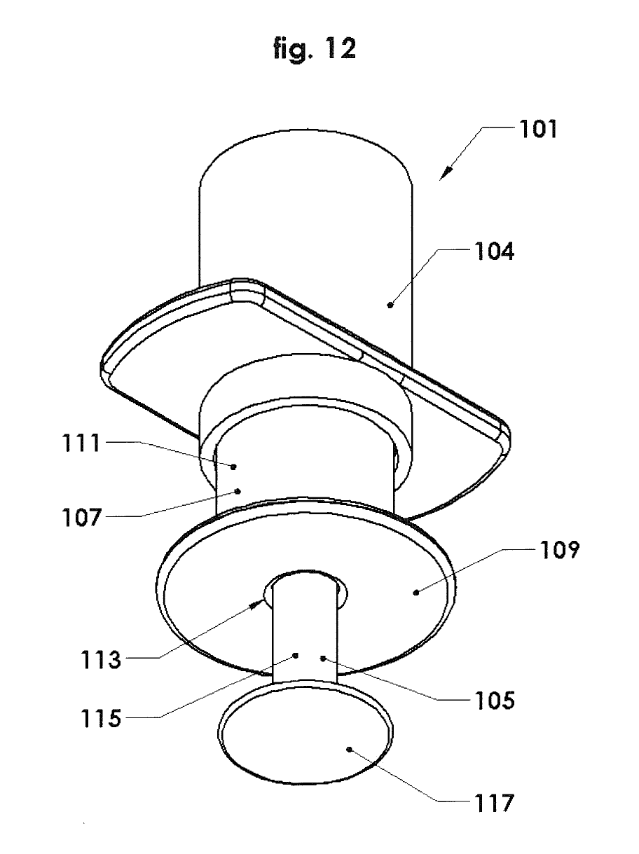

In another preferred embodiment, and referring to FIGS. 12-14, device 101 is shown and described. Generally, device 101 includes outer plunger portion 107, inner plunger portion 105, and body portion 104. It is to be understood that outer plunger portion “107” may be replaced by plunger portion “102,” and body portion 104 is preferably the same or substantially same component as described above with respect to device 100. Preferably, outer plunger portion 107 is configured to fit snugly inside body portion 104 and to move up and down within body portion 104 when pushed or pulled. Preferably, inner plunger portion 105 is configured to fit snugly inside outer plunger portion 107 when pushed or pulled. As such, each of outer and inner plunger portions 107 and 105 has an up or substantially up position and a down or substantially down position.

In a preferred embodiment, and referring to FIG. 12, outer plunger portion 107 includes an outer cylinder 111 and an outer top 109 that is attached, or formed as part of, outer cylinder 111 on a top portion of outer cylinder 111. Outer top 109 is preferably disc-shaped, and, along with outer cylinder 111, forms an opening 113 at an end of outer cylinder 111. Preferably, inner plunger portion 105 includes an inner cylinder 115 and an inner top 117 that is attached, or formed as a part of, inner cylinder 115 on a top portion of inner cylinder 115. Preferably, inner plunger portion 105 rests snugly inside outer plunger portion 107 and opening 113, and is able to move upwards or downwards within outer plunger portion 107 and opening 113. As described above with respect to plunger portion 102, outer plunger portion 107 may have one or more detents and/or beveled edges. Preferably, outer plunger portion 107 has a hollow or substantially hollow inside. In other embodiments, outer top 109 and/or inner top 117 may be omitted.

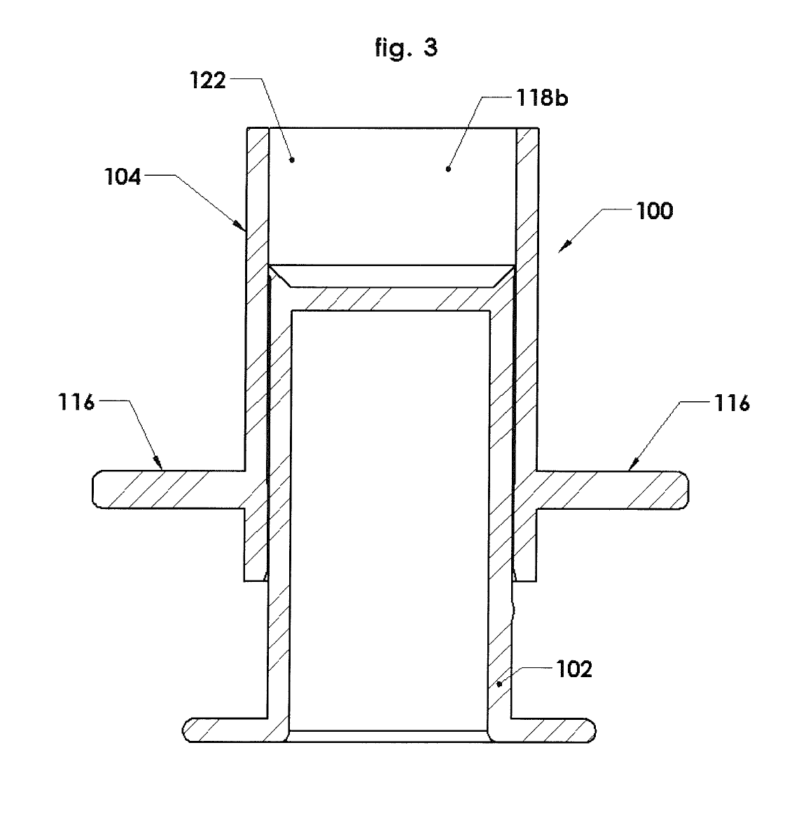

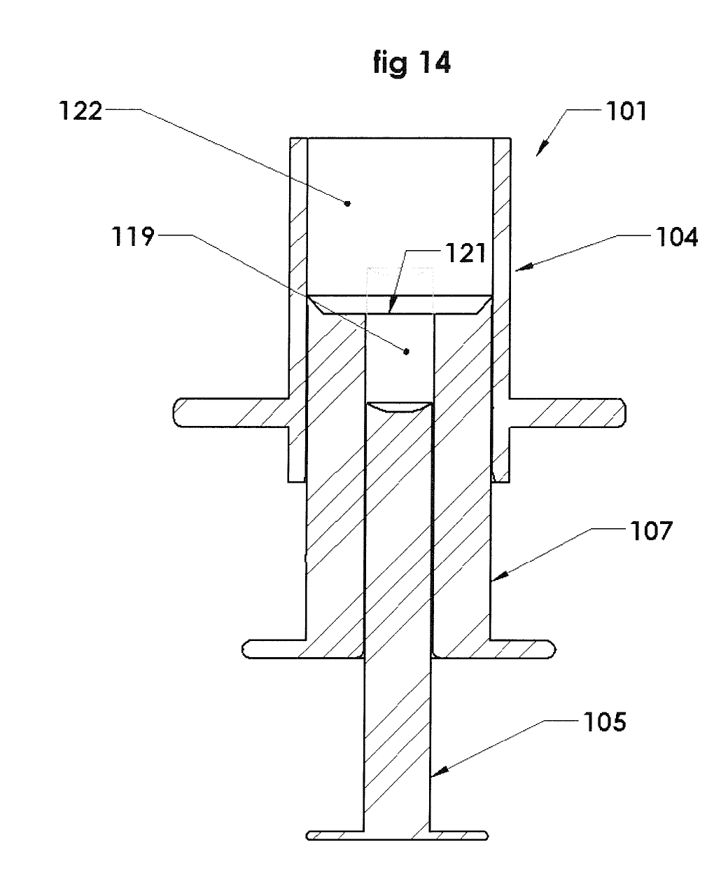

In a preferred embodiment, devices 100 and 101 of the present invention may produce a nugget of varying sizes. Referring to FIGS. 3 and 14, if, for example, a smaller nugget is desired (i.e., when the animal is smaller) then less treat and/or pill may be placed in cavity 122. If a larger nugget is desired (i.e., when the animal is larger), then more treat and/or pill may be placed in cavity 122. Additionally, referring to FIGS. 3 and 6-7, beveled edges 114 allow for increased volume in cavity 122 when plunger portion 102 is completely or almost completely pulled down. This allows for a larger nugget if desired.

In a preferred embodiment, cylinder 110 of plunger portion 102 or outer cylinder 111 of outer plunger portion 107 has a diameter of from about 0.03 to about 6.0 inches; more preferably from about 0.35 to about 4.0 inches; and most preferably from about 0.04 to about 2.0 inches. In a preferred embodiment, cylinder 110 of plunger portion 102 or outer cylinder 111 of outer plunger portion 107 has a length of from about 0.5 to about 8.0 inches; more preferably from about 1.5 to about 6.0 inches; and most preferably from about 0.75 to about 2.0 inches. In a preferred embodiment, body portion 104 has a diameter of from about 0.7 to about 6.2 inches; more preferably from about 1.2 to about 4.5 inches; and most preferably from about 1.4 to about 2.5 inches. In a preferred embodiment, body portion 104 has a length of from about 0.75 to about 7.8 inches; more preferably from about 1.25 to about 5.8 inches; and most preferably from about 1.0 to about 3.0 inches. In other embodiments, cylinder 110 and/or body portion 104 may have any other dimensions.

In a preferred embodiment, inner cylinder 115 of inner plunger portion 105 has a length of from about 2 to about 8 inches; more preferably from about 4 to about 7 inches; and most preferably from about 3 to about 5 inches. In a preferred embodiment, inner cylinder 115 of inner plunger portion 105 has a diameter of from about 0.20 inches to about 3 inches; more preferably from about 1 to about 1.5 inches; and most preferably from about 0.25 to about 0.5 inches. Preferably, the dimensions of inner cylinder 115 are configured such that it is able to fit inside outer cylinder 111 and move up and down within outer cylinder 111. In other embodiments, inner cylinder 115 may have any other dimensions.

It is to be understood that the dimensions of cylinder 110 of plunger portion 102 and outer cylinder 111 of plunger portion 107 (i.e., the length and diameter) are configured such that it is able to fit inside body portion 104 and move up and down within body portion 104. Specifically, in order to fit snuggly within body portion 104, the diameter of cylinder 110 or outer cylinder 111 (or any other portion of plunger portion 102 that moves up and down within body portion 104) should be just slightly less than diameter of body portion 104. This is so that when cylinder 110 or outer cylinder 111 is pushed up and down within body portion 104, its outer surface touches the inner surface 124b of body portion on all sides. As such, cylinder and/or body portion may have dimensions different from those described above. For example, plunger portions 102 and/or 107 and/or cylinders 110 and/or 111 and/or body portion 104 may be configured to have any dimensions depending on, for example, the size of the nugget desired and depending on the shapes of the plunger portion and the body portion. Additionally, nuggets may be produced by device 100 or 101 of the present invention and then cut to smaller dimensions. For example, large amounts of nugget may be produced by creating a manufacturing size device. Nuggets produced by the manufacturing size device may be subsequently cut into appropriate proportions.

In a preferred embodiment, and as discussed above, device 100 and/or 101 is cylindrical in shape. In other embodiments, cylinder 110, plunger portion 110, outer/inner cylinders 111 and 115, outer/inner plunger portions 107 and 105, and/or body portion 104 may be any other shape, such as rectangular, heart shaped or oval shaped, or the like. As such, the device 100 and/or 101 may be adapted to extrude nuggets of any desired shape and size. In this manner, nuggets of various shapes may be extruded from the device 100 and/or 101. For example, should a heart-shaped nugget be desired, then the cavity 122 and/or a portion of the body portion may be heart-shaped. The treat may be placed into the cavity 122 and take its shape. It is to be understood that the shape of one of the body portion or plunger portion dictates the shape of the other, as the plunger portion has to fit within the body portion. For example, some dogs may like nuggets only in the shape of a bone. As such, device 100 and/or 101 may be configured to extrude nuggets in the shape of a bone (i.e., the plunger and body may be more of rectangular shape). Alternatively, the nugget may be cut in the shape of a bone after it is compressed in the device 100 and/or 101.

In a preferred embodiment, and referring to FIGS. 1-3, device 100 of the present invention operates as follows. Preferably, a user holds device 100 in his or her hand. If not already done so, a user pulls plunger portion 102 down, using, for example, top 108 to grip plunger portion 102. Pulling plunger portion 103 down exposes a cavity 122. The user then places one or more treats in cavity 122 (shown in FIG. 3). The user then takes a pill and uses his or her hand to push it into the treat. Preferably, the treat will not fall apart as it is contained in the device 100. Due to the appropriate moisture content of the treat and/or the appropriate dimensions of the cavity 120, the treat is able to integrate with the pill when the pill is pushed into it by the user's hands. As such, the treat does not fall apart or crack when the pill is pushed into it. The use of the device 100 allows the treat to be stably held and appropriately exposed to make contact with the pill. The user may then push the plunger portion 102 up using, for example, top 108 to hoist it up. Thereafter, the user may remove the treat and pill, or “nugget,” and may feed his or her animal.

In a preferred embodiment, and referring to FIGS. 12-14, device 101 of the present invention operates as follows. Preferably, a user holds device 101 in is or her hand. The user pulls inner plunger portion 105 down, using, for example, inner top 117 to grip inner plunger portion 105. Before, during, or after pulling down on inner plunger portion 105, the user pushes up on outer plunger portion 107. Pulling down on plunger portion 105 and/or pushing up on outer plunger portion 107 exposes an inner cavity 119 (as used herein, “inner cavity” is interchangeable with “second cavity”). The inner cavity 119 preferably opens up to cavity 122 (as used herein, “cavity” is interchangeable with “first cavity”) via opening 121 on a top side of outer plunger portion 107, as best shown in FIG. 14. The user then places one or more pills in cavity 119 using his or her hands to drop the pill inside, i.e., from cavity 122. Thereafter, the user preferably pulls down on outer plunger portion 107 and places the treat into cavity 122. Subsequently, the user pushes up (or in) on inner plunger portion 105, to inject the one or more pills placed in inner cavity 119 into the treat, thereby creating an integrated pill(s) and treat (nugget). In other embodiments, inner cavity 119 may not need to be exposed and/or used, i.e., pill, along with treat may be dropped into cavity 122 without the need for pill to drop further into inner cavity 119. In this manner, inner plunger portion 105 may make contact with treat/pill via opening 121.

In a preferred embodiment, the nugget produced by the present invention is more dense (and therefore likely has a smaller size) than if the same treat and pill were simply mixed by hand. As such, the “bad taste” of the pill is masked by the “good taste” of the treat, and the animal is able to wholeheartedly consume the condensed pill and treat (the nugget). Additionally, the size of the pill does not affect its integration into the treat. A small pill will fit just as tight (and integrate just as well) as a large pill.

The foregoing embodiments are merely examples of the present invention. Those skilled in the art may make numerous uses of, and departures from, such embodiments, without departing from the scope and spirit of the present invention. Accordingly, the scope of the present invention is not to be limited or defined by such embodiments in any way, but rather, is defined solely by the following claims.

What is claimed is:

1. A method of administering a pill in a treat to an animal, comprising:
a. providing a device comprising a body portion having a hollow inside and a plunger portion configured to move up and down within the body portion, wherein the plunger portion is housed at least partially within the body portion;
b. pulling the plunger portion to a down or substantially down position within the body portion, wherein pulling the plunger portion to the down position or substantially down position exposes a cavity for receiving an animal treat and a pill;
c. placing the animal treat inside the cavity;
d. pushing a pill into the treat; thereby creating an integrated nugget; and
e. removing the nugget from the device.

2. A device comprising:
a. A body portion having a hollow inside and a plunger portion configured to move up and down within the body portion; wherein the plunger portion is housed at least partially within the body portion;
b. A cavity exposed by the downwardly movement of the plunger portion; wherein the cavity is adapted to receive an animal treat and an animal medication.

3. A device comprising:
a. A body portion having a hollow inside and an outer plunger portion configured to move up and down within the body portion; wherein the outer plunger portion is housed at least partially within the body portion;
b. An inner plunger portion configured to move up and down within the outer plunger portion; wherein the inner plunger portion is housed at least partially within the outer plunger portion;
c. A cavity exposed by the downwardly movement of the outer plunger portion; wherein the cavity is adapted to receive an animal treat.

4. The device of claim 3, further comprising an inner cavity exposed by the downwardly movement of the inner plunger portion; wherein the inner cavity is adapted to receive at least one pill.

5. A method of administering a pill in a treat to an animal, comprising:
a. Providing the device of claim 3.
